(19) United States
(12) Patent Application Publication
(10) Pub. No.: US 2012/0110713 A1
(43) Pub. Date: May 10, 2012

(54) Prosthetic liner or foot covering incorporating cork-elastomer composite and method of manufacture

(75) Inventor: Leisa Cavell Hirtz, Toronto (CA)

(73) Assignee: Leisa Hirtz, Toronto (CA)

(21) Appl. No.: 12/843,042

(22) Filed: Jul. 25, 2010

(51) Int. Cl. A41D 13/05; B29C 45/17; A43B 13/38; A41D 13/08; A43B 1/00

(52) U.S. Cl. 2/16; 2/455; 36/83; 36/43; 264/119

(57) ABSTRACT

A cork and silicone elastomer composite used to fabricate elements to protect body parts including a prosthetic roll-on liner for receiving and covering a residual limb, shoes for the feet, gloves for the hands and shoe insoles including the processes of manufacture.

### US PATENT DOCS REFERENCED

(1) U.S. Pat. No. 7,025,793
(2) U.S. Pat. No. 6,706,364
(3) U.S. Pat. No. 6,136,039
(4) U.S. Pat. No. 7,118,602
(5) U.S. Pat. No. 4,923,474
(6) U.S. Pat. No. 6,764,631
(7) U.S. Pat. No. 4,908,037
(8) U.S. Pat. No. 5,888,216
(9) U.S. Pat. No. 5,480,455
(10) U.S. Pat. No. 7,559,157

### A. FIELD OF THE INVENTION

This invention relates to a prosthetic liner or limb covering or abutting such as a foot, feet or hands integrating cork in the silicone or other similar elastomer in varying ratios to form new composite with properties to protect against injury and increase comfort.

### B. RELATED ART

With both upper and lower limb prosthesis, silicone liners have improved the comfort and suspension of the prosthetic limbs.

Traditional liners have improved suspension but consistently lead to dermatological problems. Heat dissipation and moisture build up lead to tissue degradation and interfere with the liner's ability to remain stable. Insufficient frictional forces reduce the traditional silicone sleeve from remaining stable. Moisture at the interface interferes with the negative pressure at resulting in a breaking of the vacuum seal and an increase damaging shear forces. The same principals would provide an improved environment for the feet or the hands.

In order to avoid such danger, silicone-cork composite liners address the heat, moisture, high pressure and friction properties for improved functionality. Cork's thermal properties, near zero Poisson ratio and high friction coefficient counter the negative properties of the pure silicone liner, shoes for the feet or gloves for the hands alone.

### BRIEF SUMMARY OF THE INVENTION

The present invention relates to a prosthetic sleeve member for enclosing around the residual limb to aid in stump suspension, footwear, gloves or insoles for skin protection, pressure relief with the unique attribute of heat dissipation and reduction of moisture levels, improved damping and provide an improved anti-slip means over former devices.

The present invention relates to a prosthetic liner, footwear, gloves and insoles comprising a composite of silicone elastomer in a broad range of durometers and cork granules of varying granule size and ratio for use over residual stumps to improve pressure distribution and heat dissipation, inhibit or reduce moisture levels, gage the friction coefficient to maximize stability to minimize creep and slippage as well facilitating antibacterial and antifungal benefits.

In a recent US study results indicated that 90.9% of the subjects with residual limbs reported history of skin problems. 78% presented with a problem during the exam with the dermatologist. Residual limbs are often subjected to a hot and moist environment. Both are uncomfortable and potentially harmful. Dermatological studies indicate that these conditions can compromise the health of the skin surrounding the residual limb, thus limiting the success of the prosthetic liner. Hands require protection when handling hot items. The cork and silicone composite provides protection as a glove when handling items that compromise the natural dermal covering of the hand. Feet are subjected to similar dermatological concerns in regard to requiring protection from constant contact with the surrounding environment as well as the deleterious consequences relating to the microclimate within a closed environment ie within a shoe, sock, sandal, slipper etc. Walking barefoot has many advantages to the improved health of feet. Exposure and contact with sharp items, bacteria, fungus or other pathogens limit the positive attributes obtained without proper protection. The silicone-cork foot covering with its resiliency and flexibility establishes the opportunity to have the full range of motion generally only available in a barefoot situation while protecting the derma from abrasion and potential pathogen invasion.

One possible process for manufacture proceeds as such. A mold or three-dimensional capturing of the residual limb is performed. An exact replica of the residual limb is created in plaster. Reductions of circumference to the plaster cast are made with drywall mesh and/or sandpaper. Percentages are subject to preference/experience of the prosthetic clinician and/or the silicone manufacturer, however an overall reduction of 2% circumference has proved sufficient. The cast surface is sanded and polished to the finest possible sheen and allowed to dry completely before proceeding.

A known platinum-friendly mold release is applied to the cast. Release is allowed to dry and care is again taken to ensure a polished surface remains. Cast is placed in a suitable jig for preparation of the cork and silicone composite liner.

Depending on the type of embodiment involved, equal parts of A and B components of A range of 15-80 Shore A High Consistency Elastomer are weighed out. Size and shape of the cast will determine exact amount. The silicone elastomer is repeatedly run through a two-roll mill and blended together completely to initiate vulcanization, optimally below a room temperature of 18 degrees Celsius.

Depending on the type of embodiment involved, the mixed silicone material is placed in vessel adequate for determining its physical volume. An equal volumetric amount of specifically sized granulated cork is measured out. The silicone is returned to the mill and run through to form a thin sheet onto which a small amount of the measured amount of cork is added. The resulting sheet of silicone is rolled and passed through the mill. This process is repeated several times over until the silicone has effectively embedded the entire amount of cork granules. The resulting mixture is rolled to a defined thickness relative to the product being produced. For a prosthetic liner it is generally 1.25-2 mm in thickness. The footwear, gloves and insoles will have variable thickness depending on the design of the units.

For a customized prosthetic liner, the sheet of cork-embedded silicone is then cut into sections, in an appropriate pattern, and placed as a single layer onto the plaster cast. Overlaps must be avoided and removed, and similarly, gaps must be filled. Seams are tooled until blended together. Subsequent layers of material are added to distal/terminal areas in the case of liners requiring retaining hardware. Required hardware such as the distal shuttle or umbrella or similar pin-retaining devices are placed upon the built-up area and covered with another layer of silicone material, with the reservation of any attachment opening e.g. pin threading. Areas surrounding hardware are tooled until smooth and seams are blended.

In the case of a prosthetic liner, once temporarily adhered to the cast and seamed, two to four layers of fine-weave nylon stocking are drawn over the silicone-surfaced cast and an appropriate sized Poly-Vinyl-Alcohol bag is drawn over the nylon. The cast and PVA bag are pulled into position on a vacuum-stem interface, taking care not to misalign the distal pin hardware. Vacuum pressure is applied for a period of several hours, after which both PVA bag and nylon stocking are removed. The nylon is replaced with a finishing layer of nylon-spandex pant-sock, taking care to remove unwanted wrinkles or similar material and PVA and vacuum pressure are again applied until fabric has sufficiently bonded to the silicone/cork compound.

The PVA bag is removed and the cast is placed in an industrial oven for the period stipulated by the silicone manufacturer, accounting for vulcanization and post-cure if required.

Cast is removed from the oven and allowed to cool. The cured liner is carefully rolled off of the cast and excess material is cut away from perimeters, making certain not to leave incisions that could possibly lead to splitting. The liner is fitted to the client.

In the case of injection molding the cork and silicone can be premixed and stored for the pre-determined shelf life indicated by the silicone manufacturer. Inorganic color dyes and other pigments can be added to the mixture resulting in colored end products. Flow rates and temperatures are calibrated and adjusted to enhance the flow rate of the cork and silicone composite and to avoid burning of the cork if the temperature is too high. The cork and silicone composite has the capacity for adding anti-microbial elements to aid with odor and the prevention of the proliferation of unwanted flora. Vulcanization occurs inside the mold-form. In certain circumstances addition vulcanization may be required after the product is released from the mold.

### BRIEF DESCRIPTION OF THE DRAWINGS

FIG. 1 is a lateral elevation generic view of a shoe according to the invention;

FIG. 2 is a top generic view of the shoe with a view of the opening for insertion of the foot;

FIG. 3 is a cross sectional view of a prosthetic liner

### DETAILED DESCRIPTION

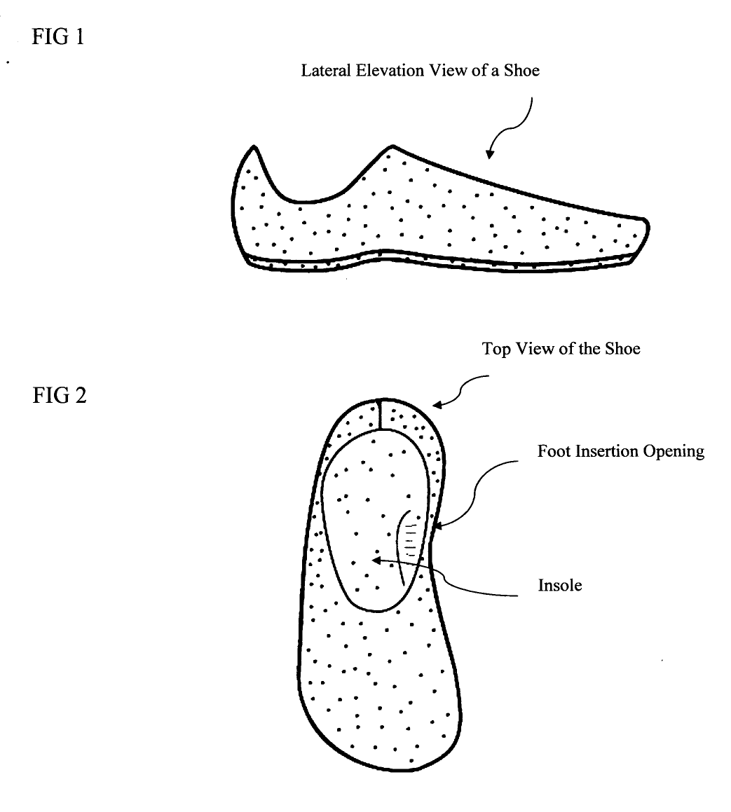

FIG. 1 lateral view of cork-silicone shoe showing possible contouring capabilities of the material.

FIG. 2 foot insertion opening and view of shoe insole location.

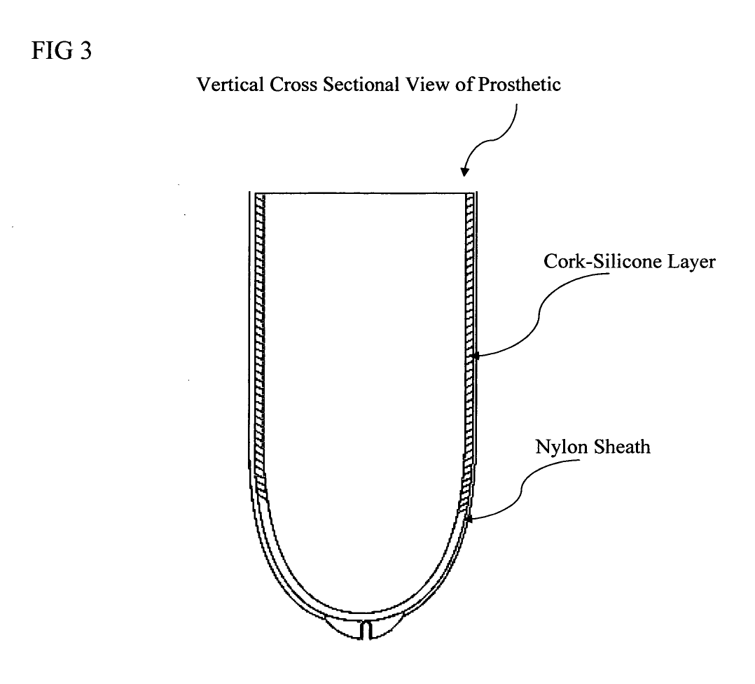

FIG. 3
1. Cork and silicone composite interior layer that interfaces directly with the skin
2. Nylon sheath cover affixed to interior cork and silicone composite layer to add wear resistance and reduce friction at the prosthetic-liner actual prosthetic-device interface.

1. A prosthetic liner, footwear, insole or glove comprising an injection molded or calendared cork-silicone highly bonded composite fabricated in varying seamless unit forms to protect body parts by sealing as much or partially enclosing the distal portion of a residual limb or intact limb as shoes for the feet, a glove for the hand or abutting a limb as an insole that has an opening at the proximal end, forms a complete, partial or is without a closure around the distal body part with the possibility of a plurality of perforations of any shape, number or size.

2. The method for making prosthetic liner, foot covering shoe, insole or glove comprising:
(a) Process to mixing and vulcanize natural cork granules with silicone to form highly bonded and durable composite mixture
(b) Calendering cork-silicone to form sheets
(c) Injection-molding cork-silicone mixture to flow into pre-fabricated shoe, insole or glove molds.
